(19) United States
(12) Patent Application Publication
(10) Pub. No.: US 2020/0223042 A1
(43) Pub. Date: Jul. 16, 2020

(54) U-JOINT CIRCLIP INSTALLATION TOOL

(71) Applicants: Steven Richard Scott, Curlew, WA (US); Jeffrey Nicholas Wilson, Roseville, CA (US)

(72) Inventors: Steven Richard Scott, Curlew, WA (US); Jeffrey Nicholas Wilson, Roseville, CA (US)

(21) Appl. No.: 16/141,821

(22) Filed: Sep. 25, 2018

(51) Int. Cl. B25B 27/20

(52) U.S. Cl. CPC B25B 27/20

(57) ABSTRACT

A tool for installing circlips in a universal joint, the tool including a handle and a blade configured to hold a circlip, the blade further including a retaining device which holds the circlip until it can be installed on a universal joint.

### TECHNICAL FIELD

The present invention relates generally to tools for installing mechanical components.

### BACKGROUND ART

Almost all motorized 4 wheel vehicles use universal joints or u-joints to transfer power from the transmission to the wheels through a differential. The u-joint allows power to be transferred at various angles so that the wheels can move up and down during operation while the engine and transmission remain stationary.

As seen in FIGS. 1-3, with FIG. 3 being a cross section of FIG. 2 taken through dashed line 3-3, a typical universal joint 1, (also called a u-joint 1), is shown. A u-joint 1 is made up of a yoke 3 that is typically mounted to the transmission (not shown) a drive shaft 2 that is typically mounted to the differential (not shown) by a cross journal 4 with four needle bearings 5 that join the yoke 3 and drive shaft 2 together, and four circlips 6 or retaining rings that fit into circlip grooves 7 to secure the bearings 5 in place. U-joints are also used on the drive axle to transfer power between the differential to the wheel.

In order to service the universal joint 1 these clips 6 must be removed from the circlip grooves 7 and the bearings 5 pressed out. Service is done to either replace damaged or worn components or in some instances to remove the differential or other drive components. During reassembly, after the bearings 5 have been installed, it can be very difficult to install the circlips 6 because of the limited amount of space inside the universal joint 1 and the location of the universal joint 1 on the vehicle. The difficulty is compounded when trying to maintain a grip on the circlip 6 while inserting it into a narrow space provided. It was necessary to present a tool that could hold the circlip securely and push it into the circlip groove 7 located on the needle bearing 5.

Currently, there are several different methods used to install the clips, but they all have various safety issues. One is to use a flat bladed screw driver, however this method is problematic because the clip can easily fall out of place because there is no way to hold the circlip. Another method is to use pliers however this rarely works because of the limited space inside the universal joint.

Thus, there is a need for a U-joint circlip installation tool which can hold a circlip while fitting it in place and which is configured to fit in the tight space inside a universal joint.

### DISCLOSURE OF INVENTION

Briefly, one preferred embodiment of the present invention is a U-joint circlip installation tool.

An advantage of the present invention is that it can hold a circlip while it is positioned to be installed in a universal joint.

Another advantage is that it is configured to fit in the narrow space within a universal joint.

A further advantage of the present invention is that it can be used in conjunction with a hammer or mallet to force the clip into place because the clips are typically made from very stiff spring steel

Another advantage of the present invention is that blade includes a V groove which accommodates a wide variety of clip diameters.

Another advantage of the present invention is that the blade includes a shoulder that supports the clip in conjunction with the magnet that supports the clip from turning during installation.

These and other advantages of the present invention will become clear to those skilled in the art in view of the description of the best presently known mode of carrying out the invention of the preferred embodiment as described herein and as illustrated in the several figures of the drawings.

### BRIEF DESCRIPTION OF THE DRAWINGS

The purposes and advantages of the present invention will be apparent from the following detailed description in conjunction with the appended drawings in which:

FIG. 1 shows an isometric view of the present u-joint installation tool and a universal joint;

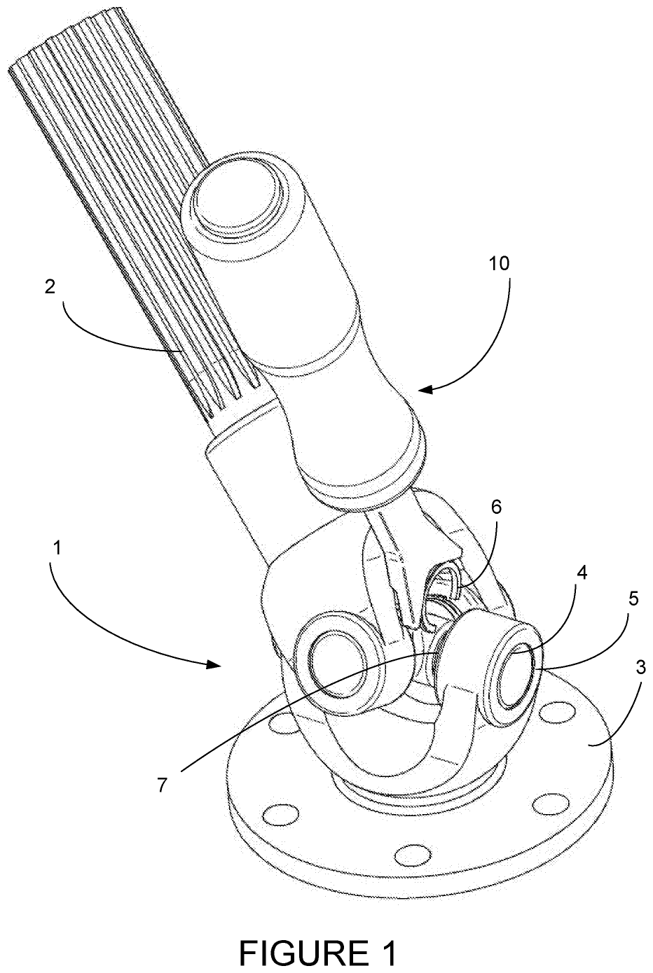

FIG. 2 shows a plan view of a universal joint;

FIG. 3 shows a cross-section of FIG. 2 taken through line 2-2;

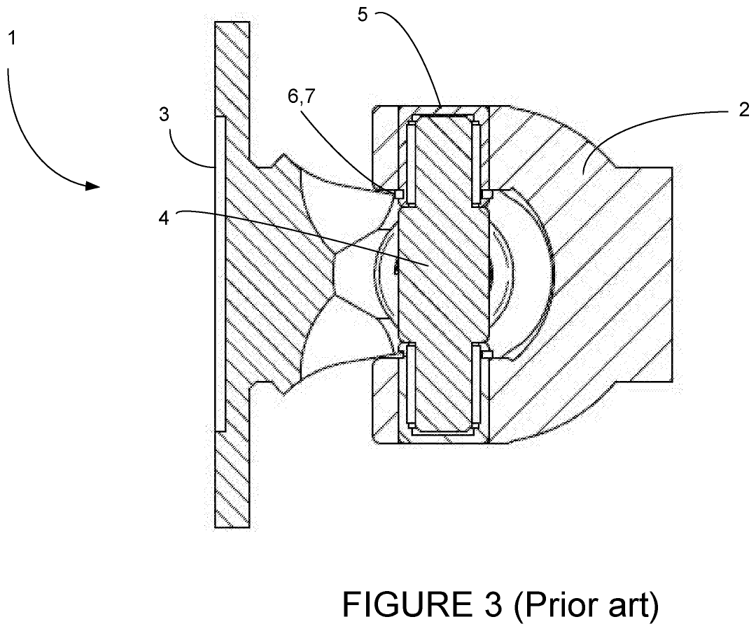

FIG. 4 shows a plan view of the u-joint circlip installation tool of the present invention; and

FIG. 5 shows a detail view of the blade of the u-joint circlip installation tool of the present invention.

### DETAILED DESCRIPTION OF THE PREFERRED EMBODIMENTS

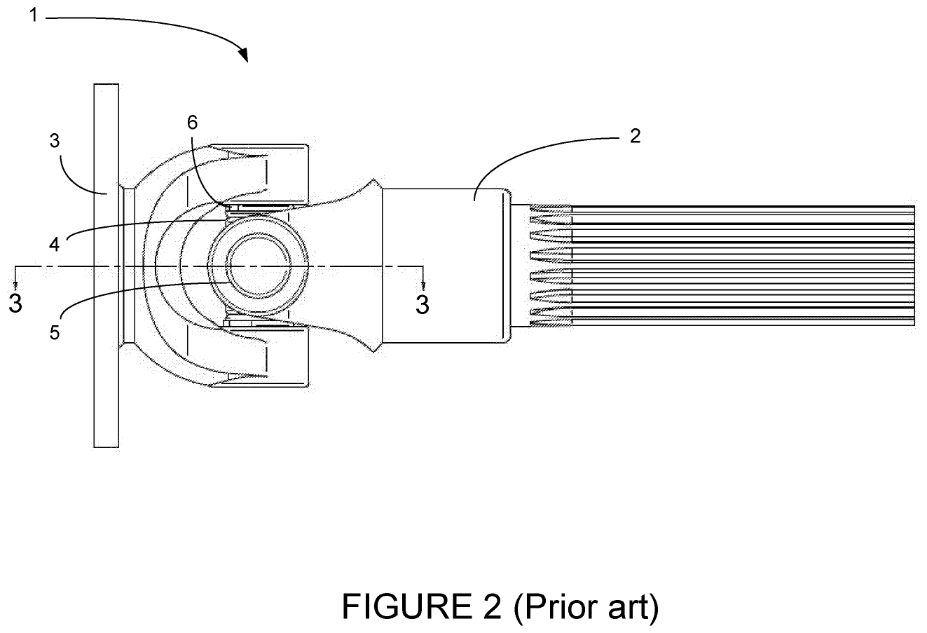

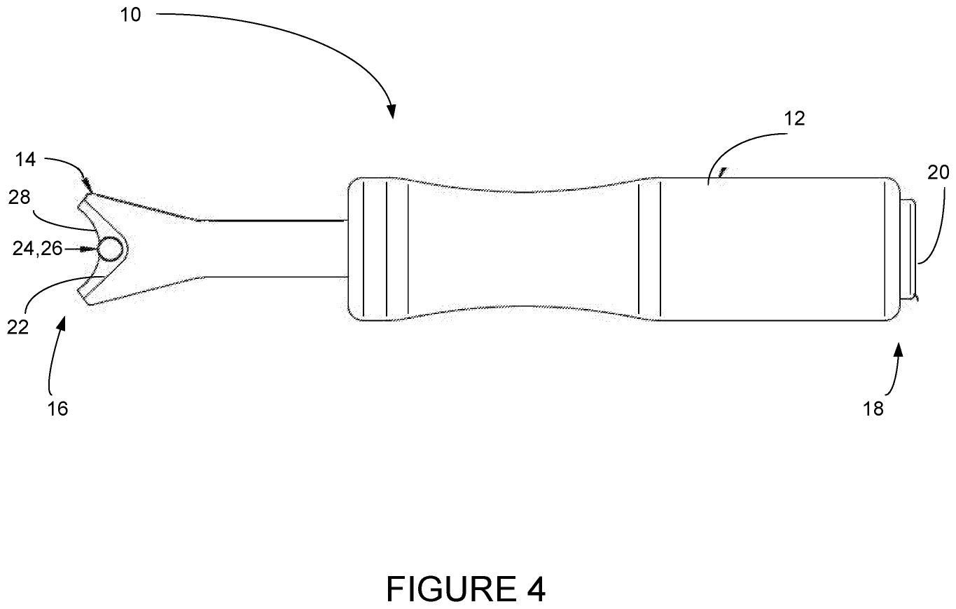

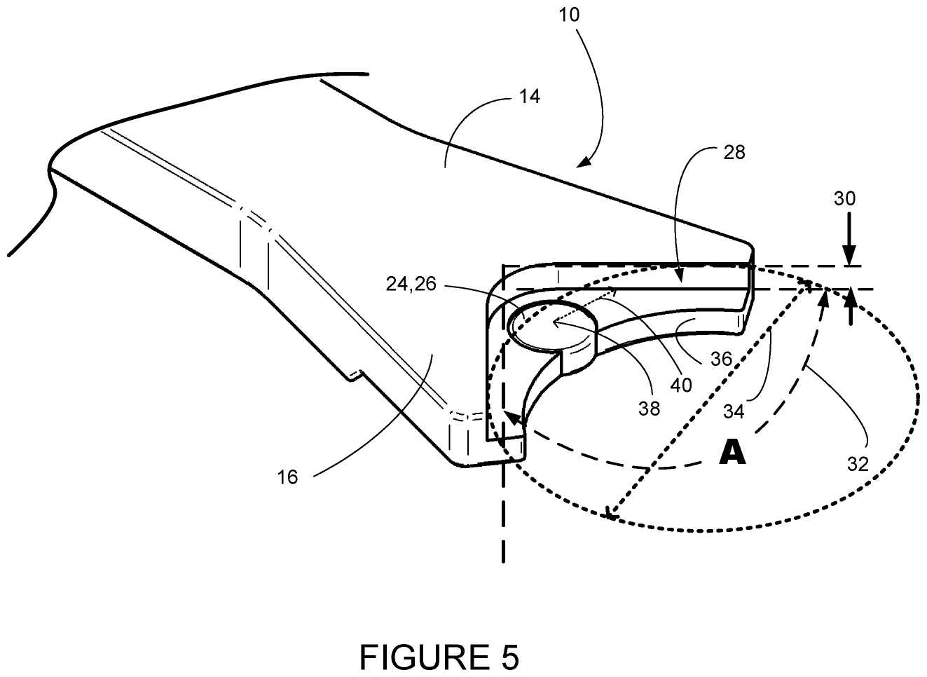

The present invention is a tool for installing circlips on u-joints. This will be referred to as a u-joint installation tool 10 and is shown in FIGS. 4 and 5. The tool 10 includes a handle 12, and a blade 14 on the front end 16, which has V-groove 22 and a shoulder 28. The rear end 18 includes a metal end cap 20. The blade 14 also includes a retaining device 24, which is preferably a magnet 26 having a center 38, which is used to hold the circlip 6 (see FIG. 2) in place on the tool 10 while it is being positioned in the circlip groove 7 (see FIG. 2).

The V-groove 22 on the blade 14 is configured to accommodate a variety of different sizes of circlips. The V-groove 22 is configured with an angle A 32 which is preferably in the range of 40 to 60 degrees. This allows circlips having diameters between 15 mm and 35 mm for a variety of sizes that accommodates most vehicles. This diameter 34 is shown for a representative circlip in dashed lines.

The retaining device 24 is preferably a magnet 26 which is secured onto the blade 14 to hold the circlip in place during installation. Circlips are generally fashioned from materials which can be held by a magnet of moderate strength. It is estimated that a magnet having strength in the range of N30 to N60 is preferred.

The placement of the magnet 26 is somewhat critical so that it will hold the circlip in place regardless of the size of the circlip. The magnet 26 is preferably located in the range between 2.5 mm and 4.5 mm from the edge of the V groove 22 to the center 38 of the magnet 26.

The handle 12 allows the user to hold the tool 10. The metal end cap 20 is preferably made of steel to prevent damage to the tool 10 as the user can tap the rear end 18 of the tool 10 with a hammer or mallet to install the circlips

As discussed above, the V groove 22 in the tip 16 allows the tool 10 to work on a variety of different sized clips. The V groove 22 has a shoulder 28 to support the circlip and stabilize it so that the circlip does not move during installation. The shoulder 28 preferably has a rounded front face 32 and a depth 30 in the range of 1.5 mm to 2.25 mm.

While various embodiments have been described above, it should be understood that they have been presented by way of example only, and not limitation.

What is claimed is:

1) A tool for installing circlips in a universal joint, said tool comprising:
a handle; and
a blade configured to hold a circlip, said blade including a retaining device which retains said circlip until it can be installed on a universal joint.

2) The tool of claim 1, wherein:
said blade includes a V-groove having an edge, said V-groove being configured with an angle which is preferably in the range of 40 degrees to 60 degrees.

3) The tool of claim 2, wherein:
said retaining device is a magnet having a center.

4) The tool of claim 3, wherein:
said magnet has a strength in the range of N30 to N60.

5) The tool of claim 4, wherein:
said magnet is located in a range of 2.5 mm to 4.5 mm measured from said edge of said V groove to the center of said magnet

6) The tool of claim 5, wherein said blade is configured to hold circlips having diameters between 15 mm and 35 mm.

7) The tool of claim 1, wherein:
said blade includes a shoulder which stabilizes a circlip as it is positioned for installation.

8) The tool of claim 7, wherein:
said shoulder has a rounded front face.

9) The tool of claim 7, wherein:
said shoulder has a depth in the range of 1.5 mm to 2.25 mm.

10) The tool of claim 1, further comprising:
a metal end cap.

11) The tool of claim 10, wherein said metal cap is a steel cap.
